(19) United States
(12) Patent Application Publication
(10) Pub. No.: US 2008/0046331 A1
(43) Pub. Date: Feb. 21, 2008

(54) Universal virtual shopping cart

(76) Inventor: Colin A. Rand, Brooklyn, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/506,504

(22) Filed: Aug. 18, 2006

(51) Int. Cl. G06Q 30/00

(52) U.S. Cl. 705/26

(57) ABSTRACT

Methods and systems are provided for improved mobile commerce through the use of a virtual shopping cart. Through the use of the present invention consumers can add prospective purchases to a virtual shopping cart and coordinate for a deferred decision for finalizing the purchases and subsequent delivery of purchased of goods.

### FIELD OF THE INVENTION

The present invention relates to shopping in a virtual environment.

### BACKGROUND OF THE INVENTION

The predominant means by which consumers shop is by visiting discrete marketplaces, i.e., physically going to stores. In a traditional retail environment, a customer may use a physical cart or basket to collect the products that he or she desires to purchase. Prior to departing the retail environment, the customer must pay for the goods and leave the shopping cart or basket at the retail environment. Consequently, a customer seeking to shop at multiple retail environments typically has a disconnected experience i.e., must use multiple different shopping carts in sequence and make multiple distinct payments. As these consumers know, this method of shopping can be time consuming, and it does not allow for a person to search efficiently for the vendor who will give the consumer the best offer, service or other type of deal.

With the advent of the Internet, consumers have been able to visit multiple virtual marketplaces without leaving their homes. Accordingly, Internet shopping has enabled consumers to locate competitive prices for desired goods. Virtual shopping carts have been developed for use in connection with this type of shopping, such as those found on the sites of many vendors, including but not limited to, Amazon.com. Unfortunately, these systems suffer from a number of drawbacks. For example, known virtual shopping carts are difficult to access away from a computing environment. Conversely, physical shopping carts are difficult to access in a publicly networked computing environment. Thus, usually a consumer will need to make a choice as to whether to shop in person or on-line and will have difficulty doing both at the same time.

This drawback is also disadvantageous to the merchant, who cannot allow his or her consumer to access simultaneously both his or her physical and virtual store. Because of these competing options, a consumer may delay a purchase in one type of store out of a concern that a better price could be realized in the other type of store. During this period of going from one type of store to the other, the consumer may also visit the store of a competitor, thereby causing the merchant to lose the sale entirely.

Further, the advantages of price rationalization on the Internet also have their limits. A person who accesses the Internet through his or her computer may be able to force competitive bidding on a good, but that bidding is typically limited to the time frame during which the consumer makes the request. Thus, competitive bidding that occurs when the consumer is away from the computing environment may not be realized.

One virtual shopping experience of which people may be aware is a bridal gift registry. Many vendors offer prospective brides and grooms the opportunity to survey their physical and/or virtual stores and to put items into virtual shopping carts for guests to purchase. Unfortunately, this system suffers from a number of drawbacks that make it inapplicable to prevalent use in mobile commerce. For example, the purchasers of the goods are not the same persons who place them on the registries, thus there is a need for an independent payment mechanism by each of the guests. Further, there is no means by which a purchaser can reserve the good in the virtual shopping cart and delay the decision for purchase while searching for a better price and/or higher quality good.

Thus, there is a need for a means by which to provide consumers and vendors with the ability to engage in a more seamless shopping experience.

### SUMMARY OF THE INVENTION

The present invention provides a means for consumers to browse for goods in both a physical and a virtual environment, and to select items that they wish to purchase in order to have an enhanced or more convenient shopping experience. Certain embodiments of the present invention also allow consumers to browse for goods in multiple physical locations, that is, sequential browsing with a final single purchase and release of any other merchandise held in the shopping cart during the browsing process.

In the e-commerce retail environment in which various embodiments of the present invention may be particularly advantageous, a customer may use a virtual cart to collect the products that he or she desires to purchase. Accordingly, a consumer can easily browse a virtual catalog adding products that he or she wishes to purchase and save that cart for a later time. This provides the consumer the ability to search other virtual catalogs for better offers or other products that he or she will actually purchase. The virtual catalog may be browsed in conjunction with visits to traditional marketplaces at either and the same time or at different times.

Thus, the universal shopping cart of certain embodiments of the present invention enables customers to move from one retail experience to another while maintaining the same shopping cart, regardless of whether the retail environment is traditional or virtual. For example, a consumer browsing in a physical retail environment can touch, feel and experience a product in order to decide if the product is worth purchasing. If the customer decides to purchase, he or she can add the product to the universal shopping cart. Next, the consumer can leave the physical location and continue to shop at other retail environments while carrying his or her purchase requests.

Various embodiments of the universal shopping cart of the present invention also permit the transformation of shopping from a vendor specific shopping experience into a consumer specific experience. Thus, these embodiments of the present invention create a new way of adding value to a shopping experience by allowing the retailer to focus on experience and setting, rather that focusing on products alone. For example, vendors can create an experience in which the customer may not realize he or she is in a retail environment. A customer could, e.g., be at an athletic gym and be able to try new equipment. Upon using and liking certain equipment, he or she could indicate purchase interest with the universal shopping cart. While continuing to use the gym facilities, the customer could then receive an alert indicating that if he or she purchases the equipment within a specified time, he or she will receive 10% off instantly. This discount could have previously been negotiated between the manufacturers and vendors and then offered back to the customer. The customer may complete the purchase and pick up his or her purchase as he or she checks out of the facility or arrange for it to be delivered to an agreed upon location, e.g., the customer's home.

The universal shopping cart of various embodiments of the present invention may also create a new environment in which advertising is configured to be a point of sale. Thus, the consumer who carries access to the virtual shopping cart with him or her, can add an item to the cart at the time of seeing the advertisement and not need to wait until he or she can enter a store. Vendors may for example, fulfill the request by having the product available where and when the customer wants to use it. Thus, according to certain embodiments of the present invention, vendors may add value to customers by facilitating this combination of point of sale and fulfillment.

Under certain embodiments of the present invention, the product may be delivered to the consumer as close to the consumer's time of use as possible. For example, a traveler on a plane who has forgotten a gift can browse an in flight magazine for missing supplies. Then, the product reseller or retailer who can provide the product closest to the consumer's time and place of desired use would make the sale. A reseller who can provide the product outside the plane immediately upon the plane's arrival on location may require the customer to carry the product to the final destination. A second reseller may be able to provide the customer the product at the customer's hotel room, alleviating the burden on the customer to carry and risk damaging the gift.

Under certain embodiments, it may not be the consumer who decides which reseller can provide the closest match to their time and place of use, but rather an agent on behalf of the consumer or group of consumers. Thus, the universal shopping cart may be linked via a computer network to clearinghouses, co-operative associations or other services that have the ability to deliver a product faster, cheaper, in better quality and/or to a better location.

A consumer may use the universal shopping cart anywhere that goods or services may be offered for sale, e.g., the Internet, a traditional marketplace, a magazine, a newspaper, a billboard, the radio, the television, etc. During the browsing process, consumers may be able to virtually tag goods that they are considering purchasing without having to finalize their purchase or physically carry the goods. By virtually tagging the item, the item is put into the purchaser's virtual shopping cart. Preferably, a physical item is reserved for the consumer such that if there are a limited number of items for sale by the vendor, a physical item corresponding to the item selected by the consumer is designated for the consumer for as long as it remains in the shopping cart. At a point decided upon by the consumer, the consumer can finalize the purchase for any or all tagged goods, which can then be picked up by the consumer at one location or delivered to the consumer at his or her home or another agreed upon delivery site. As is clear, the virtual shopping cart can hold essentially an infinite number of items, the ultimate number being a function of the power of the computer and not the size of goods.

Additionally, various embodiments of this invention may benefit merchants by having goods “returned” immediately for sale to another customer where the goods are still in original condition. Further, re-stocking expenses are reduced because preferably the physical items have not been moved until the sale is finalized.

Through the use of certain embodiments of the present invention, one can receive the benefit of automatic searching for better, if not the best products, prices and/or rebates. Similarly, products of the best or used quality can be located by this mechanism. For example, a consumer may place a first item in a virtual shopping cart. Later that day she may find one of better quality and/or price. The first item can be returned or removed from the virtual shopping cart and the second item can be placed into the virtual shopping cart. These benefits can be realized while one is away from a personal computer.

According to one embodiment, the present invention is directed to a virtual shopping system. The system comprises: (a) an initiating device, wherein said initiating device comprises a means for transmitting a product request and a (preferably unique) user identifier; and (b) a receiving device, wherein said receiving device comprises (i) a module for accessing at least one product catalog; (ii) a module for receiving said product request from at least one user; (iii) a module for recording said product request; (iv) a module for verifying the identity of the at least one user; and (v) a module for notifying a fulfillment center to deliver said product to said at least one user.

The initiating device may for example comprise at least one device selected from the group consisting of a mobile phone, an instant messenger, a website interface, a radio frequency identification (RFID) tag and reader, an interactive voice response (IVR) device, a wireless personal area network device such as Bluetooth enabled devices, a global positioning satellite proximity detecting device, and a piezoelectric button with an analog to digital converter.

Preferably, the initiating device and receiving device communicate over a network such as the Internet or through a satellite network. Further, preferably the receiving device comprises a computer.

According to a second embodiment, the present invention provides a method for enabling a virtual shopping experience, wherein said method comprises: (a) receiving a request for a product from a user, wherein said request comprises a user identification component and a product identification component; (b) verifying the identity of said user's identity; (c) verifying availability of said product; and (d) notifying a fulfillment center to deliver said product to said user. This method may, for example, be accomplished through the use of any of the initiating devices of the first embodiment.

Preferably, the method also comprises receiving security authorization data in response to said verification of said user's identity. By way of example, a security authorization data includes a user selected or user assigned personal identification number (PIN), which may contain numbers, letters, other characters, all three, possibly encoded or encrypted.

The method may also comprise verifying that the user has a spending limit high enough to cover a specific purchase amount. Alternatively or additionally, the method may further comprise transmitting a message to said user, wherein said message confirms the availability of the product. In response to the confirmation the user may send a response requesting that the transaction be completed, that the transaction be aborted or that the transaction be placed on hold. As a default, the transaction may be placed on hold until the consumer directs otherwise or a pre-set amount of time has expired (e.g., one day, one week, one month, etc.).

Further, under certain embodiments one can arrange for automatic shipping and product fulfillment without having to carry all purchases at the times that they have been purchased.

### BRIEF DESCRIPTION OF THE FIGURES

FIG. 1 is a representation of an embodiment of the present invention in which a consumer shops through use of an initiating device.

FIG. 2 is a representation of an embodiment of the present invention that indicates interaction between the consumer and a receiving device.

FIG. 3 is a representation of elements of a receiving device of an embodiment of the present invention.

### DETAILED DESCRIPTION

According to one embodiment, the present invention provides a universal virtual shopping cart also referred to herein as a “universal shopping cart.” A “universal shopping cart” is a system that enables consumers (also referred to as users) to indicate their purchase intents of a given product, and to have a reference to that product recorded in the universal virtual shopping cart. Preferably, the universal shopping cart is able to make use of a predetermined mechanism for automatically determining whether the same product is available for a better price and/or whether there is a rebate or coupon available for said product and/or to determine whether the item is available in a different condition (e.g., used, fair, good, excellent or mint condition). The system may also make use of a predetermined mechanism to make automatic payment for the product, and to use a configurable fulfillment mechanism to deliver the product to the consumer.

Hardware. The universal shopping cart is comprised of two primary hardware components that when used in combination permit the consumer and vendor to have a more seamless shopping experience. This hardware comprises both at least one initiating device and at least one receiving device. “Initiating devices” are at a minimum capable of transmitting a fixed message with a consumer identification component (also referred to herein as a consumer id or user id) and a product component (or action code). Preferably both the consumer identification component and the product component are unique to the consumer and the product. Different consumers who seek to purchase the same product would transmit the same product code but different consumer ids.

Three primary types of initiating devices exist: (1) a device that has preprogrammed product codes and permits the user to provide his or her consumer identification component, e.g., a point of purchase request device that sits in the proximity of or adjacent to a product in a store or in a poster; (2) a universal device that allows for a user to input both the product code and the user id, e.g., a device that is the property of a mall for use in any of its stores that can be temporarily borrowed by a consumer and into which the consumer can input her user id once for the a fixed time period, e.g., a day (or for each order) and input product codes as desired through for example, scanning a bar code or inputting alphanumeric characters; and (3) a device that is programmed with the user id, e.g., personal mobile (e.g., cellular) phone and into which a product code can be inputted.

Preferably, the consumer also has a means by which to receive a communication from the receiving device and to subsequently enter a security code, e.g., a PIN (personal identification number) or to respond with an answer to a question that is not generally known to the public. In one scenario, the consumer inputs the product code on a personal text messenger device that is already programmed with his or her unique user id. The product code and user id are transmitted to the receiving device. The receiving device may then send a request for the user to input his or her PIN number. Thus, here the initiating device is also a “communication device.” A communication device is a device that allows for communication between the user and the receiving device.

In the case of the point of purchase system, there may be an adjacent kiosk, or the request could, e.g., go to the user's text messenger or cellular telephone device, which would serve as a communication device that is not the same as the initiating device. Preferably, the request for the security code and the response are made in real time, i.e., immediately after the product request has been transmitted in order to facilitate the streamlining of the shopping experience.

Any initiating device will preferably have the ability to connect to a communication network and have the ability to send a message over the communication network. The message will contain the consumer identifier and product action code (also referred to as a product code). Thus, the initiating device is a user interface that is typically connected through a network to the receiving device. In its simplest form any electronic circuit that is capable of generating the required message over a communication network will suffice. Examples of initiating devices include but are not limited to mobile phones, instant messengers, websites interfaces, radio frequency identification (RFID) tags and readers, interactive voice response (IVR) devices, wireless personal area network devices such as Bluetooth enabled devices, global positioning satellite proximity detecting devices, piezoelectric buttons with analog to digital converters, personal digital assistants (PDAs) and other near field communications (NFC) devices. For convenience, it may be desirable for the initiating device to be a device that a consumer already has in her possession. Further, preferably the device is easily portable such as a mobile telephone.

Under certain embodiments, an initiating device may comprise any or all of a display function, an input mechanism, a processing mechanism, and a transmitting mechanism, all of which are already present in many mobile telephone devices. However, as the list of exemplary devices noted above demonstrates, in the simplest embodiments these mechanisms are not needed.

From a consumer's point of view it may be most convenient to use a portable device such as a cellular telephone that has text messaging capabilities and that is preprogrammed with the consumer's user id. By using a single device as both the initiating device and communication device, the consumer does not need to carry any additional items. In various embodiments a merchant would not need to provide any additional items such as a bar code scanner. Further, by using a portable initiating device with e.g., Internet access, the user can simultaneously shop in a virtual and physical environment.

“Receiving devices” are computing machines capable of at a minimum receiving purchase requests via one or more communication networks, processing a payment on behalf of the consumer and vendor (or communicating with another device that serves this function), and sending a fulfillment instruction to the vendor to deliver the product. Examples of receiving devices include but are not limited to a central server, which may comprise a micro deployment or a macro deployment. An example of a micro deployment includes but is not limited to a single store installation or a peer-to-peer network. This type of receiving device can also be used by one type of brand across one or more stores, or collectively by a few stores that may or may not be in physical proximity to one another. A macro deployment uses a similar technology but applies to a larger number of stores. Thus, the same receiving device could be used to serve vendors in diverse geographic locales, e.g., different cities, states and countries.

Preferably, the receiving device records the purchase requests that a consumer initiates. This will assist in building a consumer profile that may, e.g., be used to target the consumer with specific promotions and notices of shopping opportunities. For example a vendor may search the database for persons with certain buying preferences or who meet certain criteria and send promotions or notices to only those consumers. These promotions or notices may for example be sent to e-mail accounts of the consumers. The creation and maintenance of databases is within the knowledge and skill of persons of ordinary skill in the art and can, for example, be created using publicly available components such as Apache 2.0, Tomcat 5.5, Hibernate 3 and MySQL 5. Further, mining databases in order to locate consumers with specific preferences is also within the knowledge and skill of persons of ordinary skill. The consumer database is described in more detail below.

Preferably, the purchase requests are in the form of the unique consumer identifier and a unique product code that have been forwarded by the initiating device as described above. The physical receiving device can be located remote from the consumer and vendor or on site with the vendor. A particular vendor or a third party may operate the receiving device.

Vendors may use the receiving device to configure product offers that they would like to be made available to multiple marketplaces. For example a vendor can transmit to the receiving device via, e.g., a computer connected to the Internet or as simply as a telephone call to someone maintaining the receiving device, a request to input a logic for a specific rebate opportunity or the opportunity to purchase used versions of the product at a lower price, e.g., textbooks for college students. Consumers can also make requests of the receiving device, e.g., by text messaging to see if there are rebates or sales or by enrolling in a service that at regular intervals scans the Internet for offers or rebates on certain types of products. Commercially available receiving devices that may be used in connection with the present invention include but are not limited to any type of computer, including computers with as little as 200 Megahertz ARM processor with a megabyte of RAM. As persons of ordinary skill in the art are aware, more powerful computing devices will be needed as one increases the number of users, products and product catalogs, and network connections, and desired speed of communication and action.

The receiving device may comprise a searching and organizing server that includes a central processing unit (CPU) that is used to provide processing of input/output data between the server, a user interface (e.g., the initiating device) and/or network, and among the different modules within the server. These modules may contain the logic components described below. Thus, the CPU may execute one or more executable instructions as defined by the transaction management system described below or stored in a memory device.

An optional third piece of hardware is a universal shopping cart identification device that generates a user identification card or “id card.” This device has a computer server that allows for the input or collection of the consumer's personal data (e.g., name, address, telephone number), as well as a printing component that can generate the id card. The “id card” may have a consumer's unique identifier embedded in it, as for example printed text encoded in an RFID tag or magnetic swipe. The id card is preferably of the same size and weight as a standard credit card so that is may be placed in a consumer's wallet, or is adapted to be of a size to be placed on a consumer's key chain or to be interfaced with a cellular telephone. The id card is also preferably designed to be read by an initiating device. For example, a vendor may have a receiving device in proximity of a good offered for sale, and a consumer could swipe her id card into the receiving device in order to place the item into a virtual shopping cart.

When using an RFID tag and reader arrangement, the RFID reader may be part of the portable initiating device that is carried by a user or part of a stationary device while the tag is carried by the user. For example, when walking through a supermarket, each product may have an RFID tag while a person's cellular telephone or other portable device has RFID reader capabilities and the user id stored within it. The reader may then initiate the communication with the network and send the appropriate information, i.e., the user id and the product code, which is preferably contained within the tag adjacent to the device or advertisement. Thus, the user retains the transmitting device and travels through the marketplace with it. Alternatively, the user may carry a user id tag and adjacent to the product, there may a reader device through which the user can swipe her tag. Then the device that is adjacent to the product may transmit the information (the user id and the product code) over the communication network.

Communication Networks. The hardware components are able to communicate with each other through a communication network. A communication network may be public, such as the Internet; or private, such as carrier networks, ATM (at the moment) networks and RFID networks; and gateways, such as SMS (short message service), WAP (wireless application protocol), RFID and ATM. As persons of ordinary skill are aware, a network at its most basic level is any wired or wireless form of connective technology.

Preferably, the network is capable of transmitting a data message containing the information sent by the initiating device and delivering it to the receiving device, and transmitting communications from the receiving device to either the initiating device of the consumer or an additional communication device of the consumer. Preferably the network can also transmit information to the fulfillment center, which arranges for the product to be delivered to the consumer. The term “delivered” refers to physically transferring the product to the consumer, which may be accomplished by shipping, personal delivery to the consumer in the store (or other location, e.g., home) or arranging for the consumer to pick up the product at a predetermined site.

Logic Components. The system is preferably comprised of one or more if not all of the following logic components or modules: a transaction management system, a product catalog, a consumer database, a billing service, an accounting service, a fulfillment service and a shopping cart service. Each of these may be located within the memory of the receiving device. However, they can also be located in a remote location with which the receiving device is in communication.

The transaction management system is a component capable of sending and receiving messages from various communication networks, standardizing the contents, and managing transactional states of an interaction to provide centralized control for the various additional components. Thus, there is a transaction manager protocol that is capable of implementing a finite state machine to move through various states that implement the desired protocols. For example, when a user id and product code come in, the transaction management system may verify that they are in a standard format and if necessary either convert them to a standard format or send a response that the request be resent. Once they are in a standard format, the management system may provide the direction for execution of the steps that enable the virtual shopping cart to function.

Given the unique product identification, a digital product catalog may be searched. The catalog will preferably comprise the identity of the merchant and the product, as well as fulfillment information, i.e., whether there is inventory, its price and optionally its condition. Preferably the item can then be electronically tagged or put on reserve so that the consumer can have time to decide whether to purchase the item. Once the request has been received and the product identification verified, the item can be placed into the virtual shopping cart and put on-hold for the consumer. The physical item will not need to have been moved at this point, but it will nevertheless preferably be held for the consumer until it is removed from the shopping cart because it is either returned or purchased.

Optionally rebates can be associated with the product catalog such that when or after a request comes in and the catalog is searched, the consumer is notified of the rebate option. If the product is purchased and the consumer avails himself or herself of the rebate, the rebate may be mailed to the consumer or deposited directly into the consumer's account.

The consumer database is a component that contains at a minimum the billing records composed of a payment method (credit card, bank account, stored value or other such means), a billing address and a mobile number. The consumer database (or other module in communication with it) preferably also has the means to verify a second factor authentication mechanism for a consumer, e.g., record of a PIN number. Additional information stored in the consumer database may be for customization and personalization preferences.

The billing service is a component that uses the billing record provided by the consumer database, the merchant and product information provided by the product catalog, and instructions from the transaction management service to send a payment instruction to a payment gateway to charge e.g., a consumer credit card or debit account and deposit the funds into the specified merchant account.

The accounting service is a component that records all financial transactions and provides an audit trail for the movement of all funds from consumers to merchants, including but not limited to payments for product services from consumers and service fees to merchants. Consumers may be provided with pre-determined spending limits. These limits may reflect a previously deposited amount of funds, may be determined based on a credit authorization similar to the way that credit card companies set limits or be set by the credit issuing companies themselves, or may be set up on behalf of a consumer by another consumer, such as a parent providing a spending limit for a minor.

The fulfillment service is a component that receives a completed purchase order for a product or set of products and directs the consumer order to the merchant according to the merchant and consumer preferences. The fulfillment service may transform the data into standard industry ecommerce formats such as EDI or XML and deliver the orders to the physical fulfillment centers.

The shopping cart service is the component that manages the list of purchase requests from a consumer. This service may also initiate value add services of which merchants can make use, e.g., offering rebates if a product is within the cart for a certain amount of time, or if a combination of products are in a cart but have not been purchased (such as a washer and dryer), or if the product is in the cart of consumer who meets a certain profile (such as age, gender, or profession). This service may also manage the preferences for the consumer for billing and shipping and assist in maintaining a seamless experience for a consumer as he or she moves through various marketplaces.

Items may be put into and taken out of the shopping cart by the consumer through use of certain initiating devices if those devices, e.g., a cellular telephone has sufficient capabilities to send different types of commands. Alternatively, in the case of the point of purchase request, initiating devices may have only the functionality of sending the request, and all other communication is through a second device—the communication device, which may for example be a cellular telephone or text messenger device. Note that a personal computer could serve as the additional communication device if it is networked to the receiving device, e.g., over the Internet. Thus, a person could, e.g., deposit items into her virtual shopping cart through point of purchase request initiating devices using RFID tags at a marketplace then go to a public computer within that marketplace (or home personal computer) and decide which sales to finalize.

Fulfillment Center. The fulfillment service initiates activity of a fulfillment center, which is a physical plant dedicated to storage and preparation for delivery of products that receives the completed consumer orders from the fulfillment service. Fulfillment centers can e.g., be located in or near a retail showcase or store, at or near a stadium or concert hall, or in another location deemed separate from the purchase initiation location. Also, the fulfillment center may be located on or near the site that a consumer makes the purchase request from. For example, if a consumer makes and completes a purchase request inside a stadium, the fulfillment center may be adjacent to the stadium to allow the consumer to pick up the purchased products. Preferably he or she will be required to produce proper identification when picking up merchandise that is not shipped to a specified address such as a home. Alternatively or in addition to the on-site fulfillment center, there may also be a means to pick up, pack and ship goods that have been ordered. The fulfillment center preferably comprises a computer that can receive communications from the receiving device directing it to fulfill an order and how to arrange for delivery or pick up.

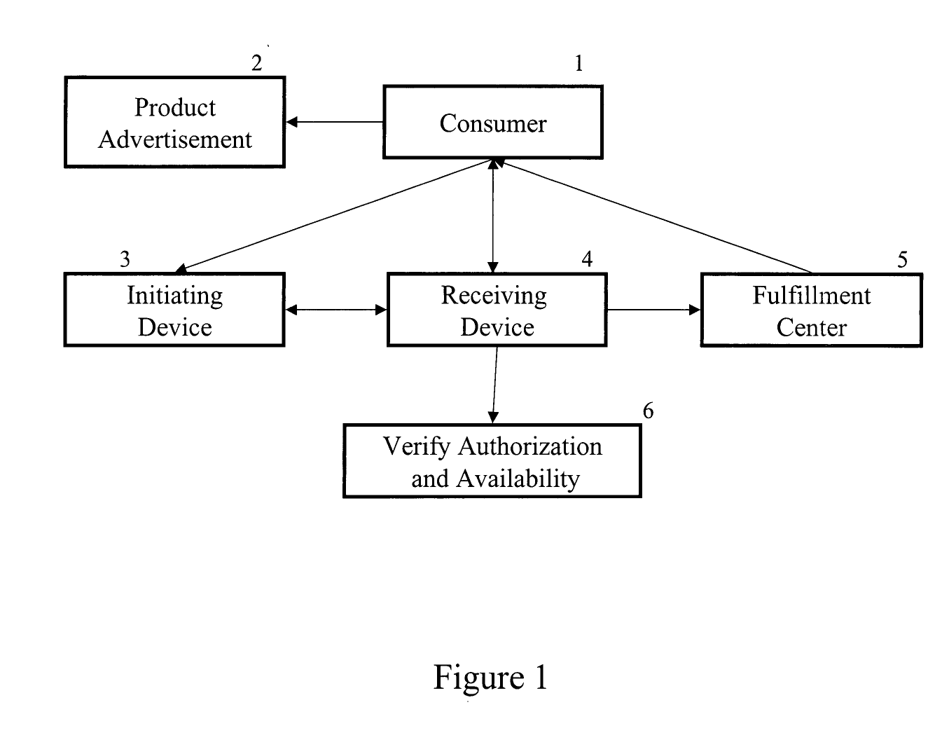

The present invention may be further appreciated by reference to the accompanying figures. In FIG. 1, a consumer I sees or hears a product advertisement 2. The product advertisement may for example be on a billboard, in a magazine, in a newspaper, on the Internet, over the television or over the radio. The consumer 1 accesses and activates an initiating device 3, which transmits a request to the receiving device 4, information that indicates that the consumer wishes for the item to be placed into her virtual shopping cart. The receiving device (or center) may verify availability of the item and authorization for the consumer to spend the requested amount 6. The receiving device may also transmit a confirmation to the initiating device 3 (or, e.g., to an e-mail account or another communication device of the consumer 1) indicating the availability of the item. Upon receipt of confirmation from the consumer that she wishes to finalize the purchase, the receiving device may notify the fulfillment center 5 to arrange for delivery.

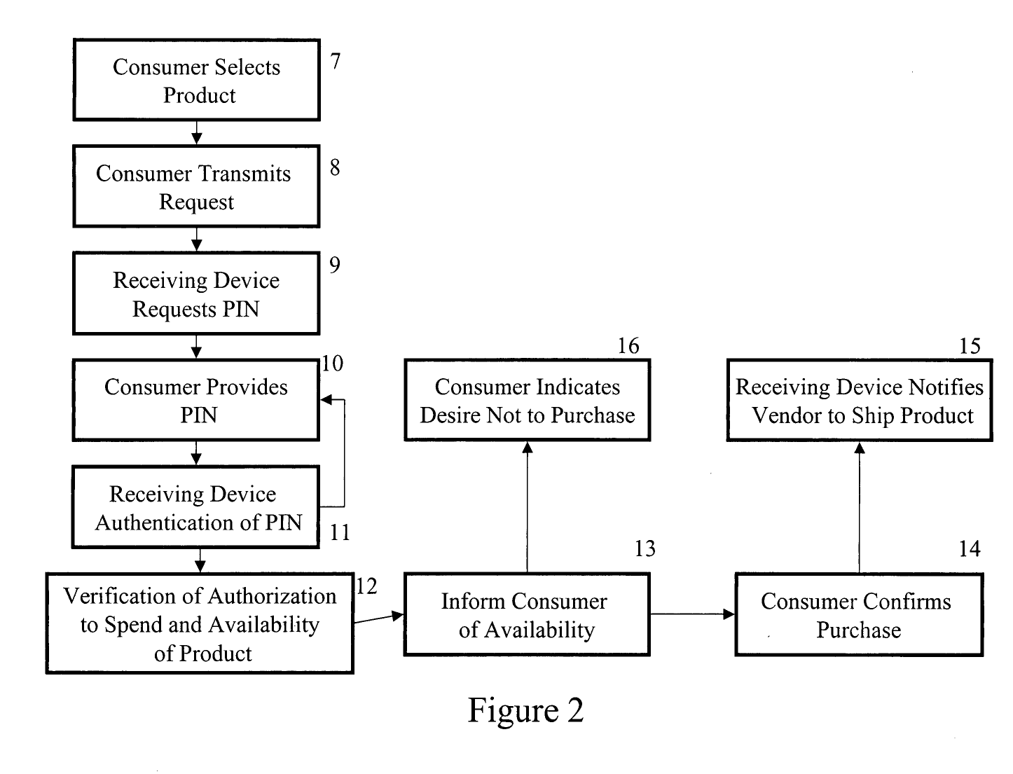

In FIG. 2, the consumer selects a product 7 and transmits the request 8 via an initiating device, e.g., through a text message application on her cellular telephone. The request contains both the consumer id and the product code. The request is transmitted to the receiving device, which sends a return request asking for the consumer's PIN number 9. In response to this request, the consumer provides a PIN number to the receiving device 10.

The receiving device then tries to authentic the PIN number in order to verify that it is the correct PIN number for the consumer id 11. If the PIN number does not match the receiving device's records another message is sent back to the consumer, who must re-enter her PIN 10. The system can be configured such that the consumer has a limited number of times to enter a correct PIN before the consumer's account is frozen. This feature adds security for the consumer. In these cases, the consumer could, e.g., be required to contact the operator of the receiving device via telephone, the Internet or other means in order to un-freeze the account by proving that she is the authorized user. For example, the consumer could be required to provide personal information that is not generally known to the public (e.g., social security number or mother's maiden name).

Once the PIN number is verified, the receiving device will verify both that the requested item is available and that the consumer has authorization to spend the amount of the item 12. These two conditions can be verified simultaneously or sequentially. In case of the latter, either condition may be verified first. If either of these conditions is not met, the receiving device can transmit a message back to the consumer through for example the initiating device to inform the consumer of the condition.

If the conditions are satisfied, the consumer is informed of the availability of the product and that she can purchase it 13. The client can confirm the purchase at that time 14 or have the purchase held in her virtual shopping cart. If the consumer ultimately decides not to purchase the item, she can notify the receiving device of this as well 16. If the consumer does confirm through the receiving device that she wants to finalize the purchase, notice may be provided to the vendor or distribution center 15, which arranges for the item to be available for the consumer to pick up or for the item to be shipped to the consumer.

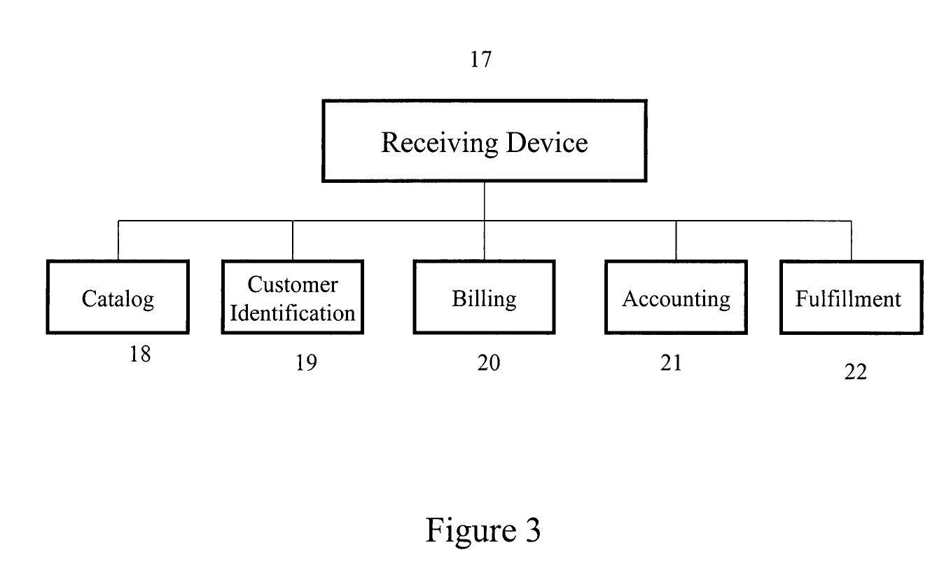

FIG. 3 provides a representation of the functionalities that may be within a receiving device or about which a receiving device may transmit and/or receive information. Thus, the receiving device 17 has access to or contained within it, at least one product catalog 18, a means to verify customer identification 19, a means to arrange for billing of a customer or the customer's account 20, a means to provide for accounting of customers' accounts and vendors' accounts 21, and a means to contact a fulfillment center 22.

The instructions for any of the methods of the present invention may be contained in a computer readable storage medium storing instructions that, when executed by a computer, cause the computer to perform those methods. For example, the computer readable storage medium may contain instructions for a method for electronic shopping, that comprises: (a) receiving a request for a product from a user, wherein said request comprises a user identification component and a product identification component; (b) verifying said user's identity; (c) verifying availability of said product; and (d) notifying a fulfillment center to deliver said product to said user. Computers can similarly be used to implement all other methods of the present inventions.

### EXAMPLE

The following is a prophetic example and is not intended to limit the scope of the present invention in any way.

A consumer may enter a retail showcase shop and see a product that he wants to purchase. The product has a product code. The consumer may send a text message to a receiving device that manages his universal virtual shopping cart. The message will include the product code indicating a desire to purchase the product and because it is sent from a preprogrammed text messenger device, it will also contain the user id. Prior to sending this request the consumer had selected to receive alerts if rebates can be found for the product.

The receiving device sends a request for the user to input his PIN. The user inputs the correct PIN. The receiving device determines that the product is available and that the consumer has sufficient funds pre-paid in his account. The receiving device sends a request asking the consumer whether he wishes to purchase the good. The consumer sends a message requesting that the good be placed on hold.

The consumer continues to browse the showcase and directs the placement of other products into the shopping cart. He receives an alert that a rebate has been found and can be used if the transaction for one of the products is completed within an hour. The consumer decides to act on the alert and replies to make a purchase of the product that has the rebate while returning some other products that are in the shopping cart and leaving the remaining products on hold. The fulfillment center is directed to send the selected product to the consumer's home and executes the direction.

What is claimed:

1. A virtual shopping system comprising:
a. an initiating device, wherein said initiating device comprises a means for transmitting a product request and a user identifier; and
b. a receiving device, wherein said receiving device comprises
i. a module for accessing at least one product catalog;
ii. a module for receiving said product request from at least one user;
iii. a module for recording said product request;
iv. a module for verifying the at least one user's identity; and
v. a module for notifying a fulfillment center to deliver said product to said at least one user.

2. The virtual shopping system of claim 1, wherein the initiating device comprises at least one device selected from the group consisting of a mobile phone, an instant messenger, a website interface, a radio frequency identification tag and reader, an interactive voice response device, a wireless personal area network device, a global positioning satellite proximity detecting device, a piezoelectric button with an analog to digital converter, a personal digital assistant and a near field communications device.

3. The virtual shopping system of claim 2, wherein the initiating device is a mobile phone.

4. The virtual shopping system of claim 2, wherein the initiating device is an instant messenger.

5. The virtual shopping system of claim 1, wherein said transmitting is over the Internet or through a satellite network.

6. The virtual shopping system of claim 1, wherein said receiving device comprises a computer.

7. The virtual shopping system of claim 1, wherein said fulfillment center comprises a computer and said computer comprises a means to receive a communication from said receiving device over a network.

8. A method for providing a virtual shopping experience, wherein said method comprises:
a. receiving a request for a product from a user, wherein said request comprises a user identification component and a product identification component;
b. verifying said user's identity;
c. verifying availability of said product; and
d. notifying a fulfillment center to deliver said product to said user.

9. The method according to claim 8, wherein said request is received from an initiating device.

10. The method according to claim 9, wherein said initiating device comprises at least one device selected from the group consisting of a mobile phone, an instant messenger, a website interface, a radio frequency identification tag and reader, an interactive voice response device, a wireless personal area network device, a global positioning satellite proximity detecting device, a piezoelectric button with an analog to digital converter, a personal digital assistant and a near field communications device.

11. The virtual shopping system of claim 10, wherein the initiating device is a mobile phone.

12. The virtual shopping system of claim 10, wherein the initiating device is an instant messenger.

13. The method according to claim 8 further comprising receiving security authorization data in response to said verifying said user's identity.

14. The method according to claim 8 further comprising verifying a spending limit for said user.

15. The method according to claim 8 further comprising transmitting a message to said user, wherein said message confirms the availability of said product.

16. The method according to claim 15 further comprising receiving a request from said user to complete a transaction.

17. The method according to claim 15 further comprising receiving a request from said user to place a transaction on hold.

18. The method according to claim 15 further comprising receiving a request from said user to abort a transaction.

19. A shopping system comprising:
a. an initiating device, wherein said initiating device comprises a means for transmitting a product request and user identifier, wherein said initiating device is a mobile phone and said product request identifies at least one product;
b. a receiving device comprising:
i. a module for accessing at least one product catalog;
ii. a module for receiving said product request from at least one user;
iii. a module for recording said product request;
iv. a module for verifying the at least one user's identity and availability of said product;
v. a module for notifying a fulfillment center to deliver said product to said at least one user; and
c. a communication network, wherein said communication network links said receiving device and said initiating device.

20. A computer readable storage medium storing instructions that, when executed by a computer, causes the computer to perform the method of claim 8.

21. The virtual shopping system of claim 1 further comprising a shopping cart identification card, wherein said identification card records said user identifier.

22. The virtual shopping system of claim 19 further comprising at least one shopping cart identification card, wherein said at least one shopping cart identification card records said at least one user's identity.
